(19) United States
(12) Patent Application Publication
(10) Pub. No.: US 2022/0291406 A1
(43) Pub. Date: Sep. 15, 2022

(54) METHOD AND SYSTEM FOR ESTIMATING THICKNESS OF DEEP RESERVOIRS

(71) Applicant: SAUDI ARABIAN OIL COMPANY, Dhahran (SA)

(72) Inventors: Maher I. Almarhoon, Al Qatif (SA); Wisam AlKawai, Qatif (SA)

(73) Assignee: SAUDI ARABIAN OIL COMPANY, Dhahran (SA)

(21) Appl. No.: 17/197,730

(22) Filed: Mar. 10, 2021

(51) Int. Cl. G01V 1/30

(52) U.S. Cl. CPC G01V 1/306; G01V 2210/1293; G01V 2210/1295; G01V 2210/1425; G01V 2210/1423; G01V 2210/624

(57) ABSTRACT

A method for estimating a thickness of a deep reservoir may include obtaining seismic data relating to the deep reservoir. The method may include performing spectral decomposition to obtain one or more frequency components from the seismic data. The method may include identifying a number of mono-frequency horizons corresponding to high frequencies in the seismic data, determining whether the deep reservoir is a thin reservoir based on the number of mono-frequency horizons, and estimating the thickness of the deep reservoir when the deep reservoir is determined to be the thin reservoir.

### BACKGROUND

Horizons refer to surfaces or seismic reflectors that separate different rock layers in depositional environments. For example, a horizon can be a boundary between two different geological layers in a subterranean region. Horizons may be perceived using methods for decomposing seismic data into frequencies to indicate a point in which two different rock layers meet. Interpreting whether a meeting point between two different rock layers occurs in a thin reservoir is usually performed by taking direct source rock samples from a formation and is not usually performed using the seismic data as a starting point. Further, when seismic data is used, seismic data is usually required to be processed along with well data to look at characteristics in the seismic and well response to infer geologic boundaries in the formation. This requirement to combine seismic data and well data prevents advanced thickness analysis of a formation during petroleum exploration.

### SUMMARY

In general, in one aspect, embodiments disclosed herein relate to a method for estimating a thickness of a deep reservoir. The method includes obtaining seismic data relating to the deep reservoir. The method includes performing spectral decomposition to obtain one or more frequency components from the seismic data. The method includes identifying a number of mono-frequency horizons corresponding to high frequencies in the seismic data, determining whether the deep reservoir is a thin reservoir based on the number of mono-frequency horizons, and estimating the thickness of the deep reservoir when the deep reservoir is determined to be the thin reservoir.

In general, in one aspect, embodiments disclosed herein relate to seismic survey system. The system includes a generator device that transmits a signal to an area of interest (AOI), a collector device that obtains a response to the signal from the AOI, and a controller device. The controller device determines seismic data based on the signal and the response to the signal. The controller device performs spectral decomposition to obtain one or more frequency components from the seismic data. The controller device identifies a number of mono-frequency horizons corresponding to high frequencies in the seismic data, determines whether the deep reservoir is a thin reservoir based on the number of mono-frequency horizons, and estimates the thickness of the deep reservoir when the deep reservoir is determined to be the thin reservoir.

In general, in one aspect, embodiments disclosed herein relate to a non-transitory computer readable medium storing instructions executable by a computer processor. The instructions include functionality for obtaining seismic data relating to the deep reservoir. The instructions include functionality for performing spectral decomposition to obtain one or more frequency components from the seismic data. The instructions include functionality for identifying a number of mono-frequency horizons corresponding to high frequencies in the seismic data, determining whether the deep reservoir is a thin reservoir based on the number of mono-frequency horizons, and estimating the thickness of the deep reservoir when the deep reservoir is determined to be the thin reservoir.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a schematic diagram showing a system for estimating a thickness of a deep reservoir.

FIG. 2 shows a schematic diagram showing a generator device in accordance with one or more embodiments.

FIG. 3 shows a schematic diagram showing a collector device in accordance with one or more embodiments.

FIG. 4 shows a schematic diagram showing a controller device in accordance with one or more embodiments.

FIG. 5A shows a schematic diagram showing an example of an offshore system for estimating a thickness of a deep reservoir.

FIG. 5B shows a schematic diagram showing an example of an onshore system for estimating a thickness of a deep reservoir.

FIG. 6 shows a block diagram showing a method for estimating a thickness of a deep reservoir in accordance with one or more embodiments.

FIG. 7A shows an image showing a thickness of a deep reservoir in accordance with one or more embodiments.

FIG. 7B shows an image showing a thickness of a deep reservoir at a first depth.

FIG. 7C shows an image showing a thickness of a deep reservoir at a second depth.

FIG. 8 shows an image showing a thickness of a deep reservoir at a third depth.

FIG. 9 shows a flowchart in accordance with one or more embodiments.

FIG. 10 shows a computer system for estimating a thickness of a deep reservoir in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure are directed towards a method and a system for estimating thickness of hydrocarbon reservoirs or any geologic layers in the subsurface directly from the observed peak frequency in the seismic data. The method and the system may estimate a thickness of deep thin reservoirs targeted for petroleum exploration. The method and the system mitigate any difficulties in estimating thickness of deep thin reservoirs through conventional seismic interpretation techniques by developing (i.e., resolving) images of thinner layers using seismic data.

Thin reservoirs are difficult to resolve through conventional seismic interpretation once the seismic data is below a tuning thickness. Thin reservoirs below a tuning thickness tend to result in observed relatively high peak frequency of the seismic data due to the interference of events below the seismic resolution. Specifically, the vertical resolution of seismic data is limited and does not exceed one quarter of the seismic wavelength (i.e., λ/4=Vₚ/4f, where λ is the seismic wavelength, Vₚ is the seismic velocity, and f is the seismic frequency). Resolving thin reservoirs of the tuning thickness limit (i.e., Z=λ/4) is difficult because the corresponding reflections to these thin reservoirs intervene with each other. Further, the resolution of the seismic data decreases with depth because high seismic frequencies are attenuated as the seismic waves propagate into great depths. This makes it more difficult to resolve deep thin reservoirs. Such reservoirs can be interpreted on conventional seismic data.

In some embodiments, the frequency characteristics of thin reservoirs are derived from collected seismic data. In the method and the system, various frequency components of amplitude spectrum of the seismic data may be obtained through spectral decomposition. Then, thin reservoirs may be picked at mono-frequency horizons corresponding to high frequencies (i.e., peak frequencies) of the spectrum. At the same time, high peak frequencies may be identified as the frequencies where the thin reservoirs show the highest degree of illumination.

Horizons refer to surfaces or seismic reflectors that separate different rock layers in depositional environments. Horizon picking or tracking refers to a process of identifying or determining a seismic reflector between two geological layers. Horizon picking may be performed manually or automatically. For example, software tools may execute auto-horizon picking algorithms to perform horizon picking automatically based on seismic data. Both manual horizon picking and auto-horizon picking can be difficult, time consuming, and error-prone because of the complexity of the geology, poor signal to noise ratio of the seismic data, or both.

In one or more embodiments, to estimate thickness, a one-way travel time of seismic waves with a geologic layer T can be approximated as a function of the high peak frequency (i.e., fₚₑₐₖ) as follow:

$$T = \frac{1}{{f}_{peak}} \qquad ( 1 )$$

Based on equation (1), the thickness of any geologic layer Z can be estimated as follow:

$$Z = {V}_{int} \cdot T = \frac{{V}_{int}}{{f}_{peak}} \qquad ( 2 )$$

Where Vᵢₙₜ is the interval velocity of P-waves in a particular geologic layer.

In one or more embodiments, the thickness may be estimated based on an illumination on an image mapping the deep reservoir. In this regard, the seismic data may be obtained from an area of interest, the thickness may be calculated using equations (1) and (2), and the results may be mapped from a database onto a map showing an illumination gradient corresponding to a calculated thickness. Advantageously, an operator may estimate a thickness of the deep reservoir based on the illumination level seen in the generated image.

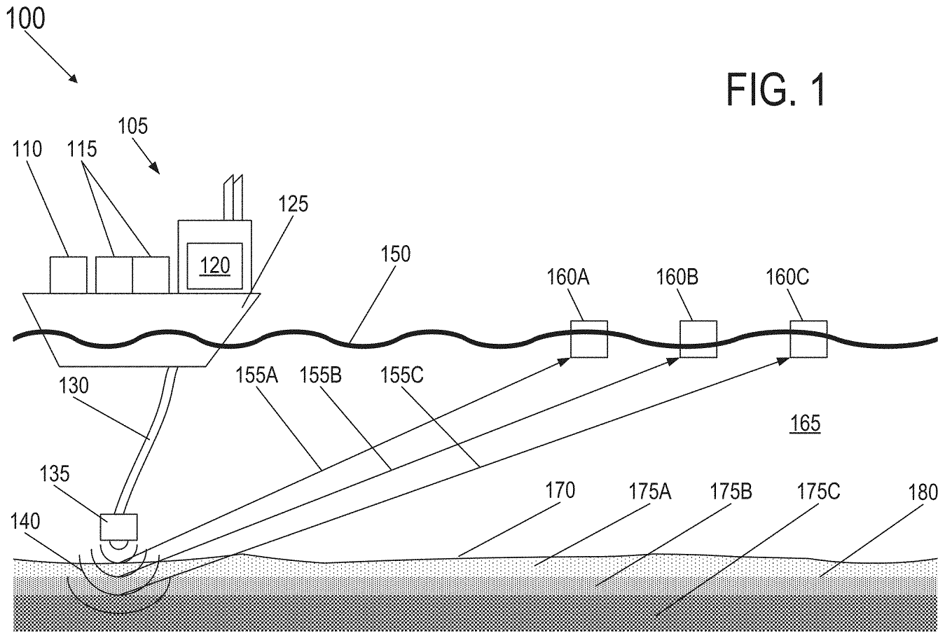

FIG. 1 shows a schematic diagram illustrating a seismic survey system 100 for collecting seismic data from a deep reservoir 180 located below a surface 150 of the ocean 165. The seismic survey system 100 includes a generator device 135 that generates various sampling signals 140 towards an area of interest (AOI) located at a testing surface 170. The testing surface 170 absorbs a portion of the various sampling signals 140 and reflects signals 155A, 155B, and 155C a corresponding depths 175A, 175B, and 175C. Once the reflected signals 155A-155C reach the surface, they may be retrieved by one or more corresponding collector devices 160A, 160B, and 160C. Each collector device out of the collector devices 160A-160C may be located on the ocean surface 150 and disposed at an angle corresponding to a location for receiving the corresponding reflected signals 155A-155C. The collector devices 160A-160C receive the corresponding reflected signals 155A-155C and share the received information with a controller device 120 that processes seismic data received from the reflected signals 155A-155C.

The seismic data is used for frequency-based horizon interpretation. The offshore seismic survey system 100 can be used on land, offshore, or in another subterranean region. As shown in FIG. 1, in offshore operations, a vessel 125 may act as a surveying site 105 for processing the seismic data. In offshore operations, the generator device 135 may be tethered through a conveyance mechanism 130 that deploys the generator device 135 to a strategic location closer to the AOI where multiple depths may be identified.

The vessel 125 may be a movable surveying site or a permanently moored vessel. The surveying site 105 may include at least one operations hub 110, one or more storage units 115, and the controller device 120. The operations hub 110 may include multiple laboratories and testing stations for operators to process seismic data. The operations hub 110 may include one or more display panels for analyzing images generated using the seismic data. The operations hub 110 may further include data storage stations that provide storage space for the seismic data and any processed data thereof. The storage unit 115 may be one or more locations for safeguarding industrial equipment used in the process of petroleum exploration. Further, the storage unit 115 may include a memory for storing well logs and data regarding sampling signals 140, reflected signals 155A-155C, and their seismic data for performing simulations. In some embodiments, the controller device 120 may include a reservoir simulator (not shown). The reservoir simulator may include hardware and/or software with functionality for generating one or more reservoir models regarding the deep reservoir 180 and/or performing one or more reservoir simulations. The reservoir simulator may perform production analysis and estimation based on one or more characteristics associated to the deep reservoir 180. While the reservoir simulator may be included in the controller device 120 at the surveying site 105, the reservoir simulator may be located away from the surveying site 105. In some embodiments, the reservoir simulator may include a computer system disposed to estimate a depth of the depths 175A, 175B, and 175C. The reservoir simulator may use the memory for compiling and storing historical data about the deep reservoir 180. The historical data may be information including reservoir depth, well production rate, packer depth, and/or casing depth.

Subsurface sedimentary structures that trap oil such as faults, folds, and domes, may be mapped by one or more reflected waves. The amplitude, phase, frequency, and travel time information of the waves at specified locations within the deep reservoir 180 may be recorded as seismic data. In this regard, the frequency information of the seismic data may be used for horizon interpretation. Rather than having a single frequency, the seismic data may include multiple frequency components and a bandwidth of a spectrum or a range in a frequency domain. For example, the recorded seismic data may have a bandwidth of 10-150 Hz in the frequency domain.

The seismic data may include two-dimensional (2D), three-dimensional (3D), or higher dimensional seismic data. For example, the seismic data may include 3D seismic volumes. Each 3D seismic volume can include sets of seismic traces organized into 2D seismic lines, in which each trace has respective coordinates and each data point of the trace corresponds to a certain seismic travel time or depth. In some embodiments, seismic data may be collected in 2D seismic lines. The seismic data may include full stack seismic volumes that span the full bandwidth of the seismic data (for example, from 10 Hz to 1000 Hz).

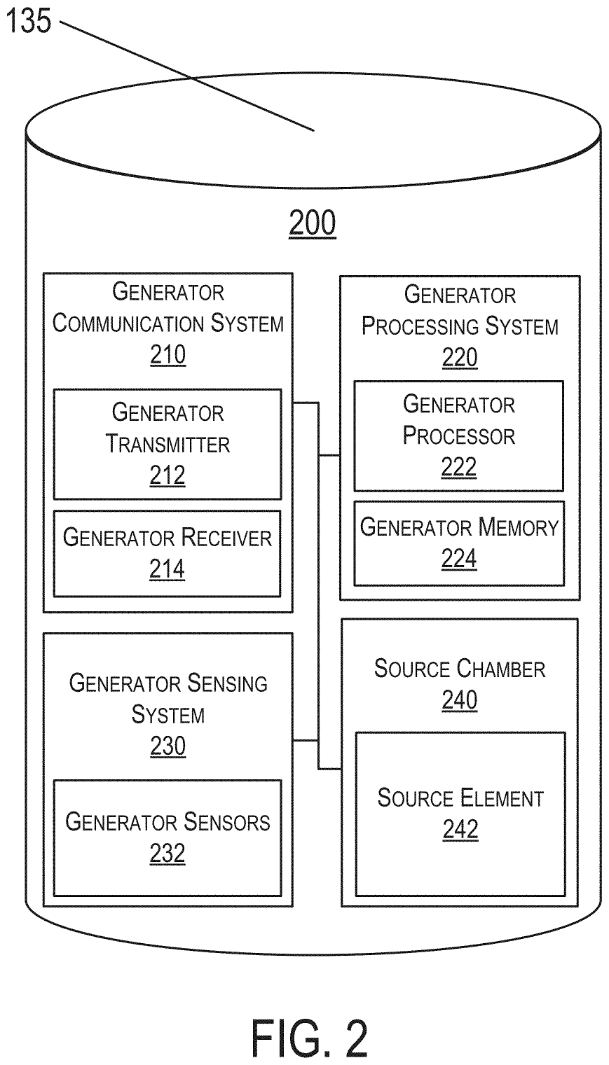

FIG. 2 shows a schematic diagram showing various systems that may be incorporated into the generator device 135. In some embodiments, the generator device 135 includes electronic components that enable the generator device 135 to perform communication functions, data collecting functions, and/or processing functions. In some embodiments, the generator device 135 has a generator housing 200 that includes generator communication system 210, generator processing system 220, and generator sensing system 230 coupled to the source chamber 240 containing a source element 242. As noted above, the generator device 135 may be hosted inside the vessel 125 or disposed at a distance from the vessel 125. In some embodiments, the generator device 135 is deployed above the surface 170 in the manner shown in FIG. 1. In this case, the generator housing 200 may be formed to resist sub-nautical pressures and to resist hazardous environments.

The generator communication system 210 may include communication devices such as a generator transmitter 212 and a generator receiver 214. The generator transmitter 212 and the generator receiver 214 may transmit and receive communication signals, respectively. Specifically, the generator transmitter 212 and the generator receiver 214 may communicate with one or more control systems located at a remote location through a wired connection. In some embodiments, the generator communication system 210 may communicate wirelessly with the collector communication system 310 of the collector device 160. In some embodiments, the generator communication system 210 may act as a relay to transfer information from the collector device 160 to the controller device 120 located at the vessel 125.

The generator processing system 220 may include a generator processor 222 and a generator memory 224. The generator processor 222 may perform computational processes simultaneously and/or sequentially. The generator processor 222 may determine information to be transmitted and processes to be performed using information received or collected. Similarly, the generator processor 222 may control collection and exchange of geospatial information from the generator device 135.

The generator sensing system 230 may include generator sensors 232. The generator sensors 232 may be sensors that collect physical data from the environment surrounding the generator device 135 (i.e., sensing conditions at a predetermined depth in the ocean 165). The generator sensors 232 may be lightweight sensors requiring a small footprint. These sensors may exchange information with each other and supply it to the generator processor 222 for analysis. The generator sensors 232 may be logging tools of an electrical type, a nuclear type, a sonic type, or another type. The generator sensors 232 may release signals (i.e., electrical, nuclear, or sonic) through a signal generator at the source chamber 240. The source chamber 240 may include a source element 242 that is used as a catalyst for generating one or more sampling signals 140.

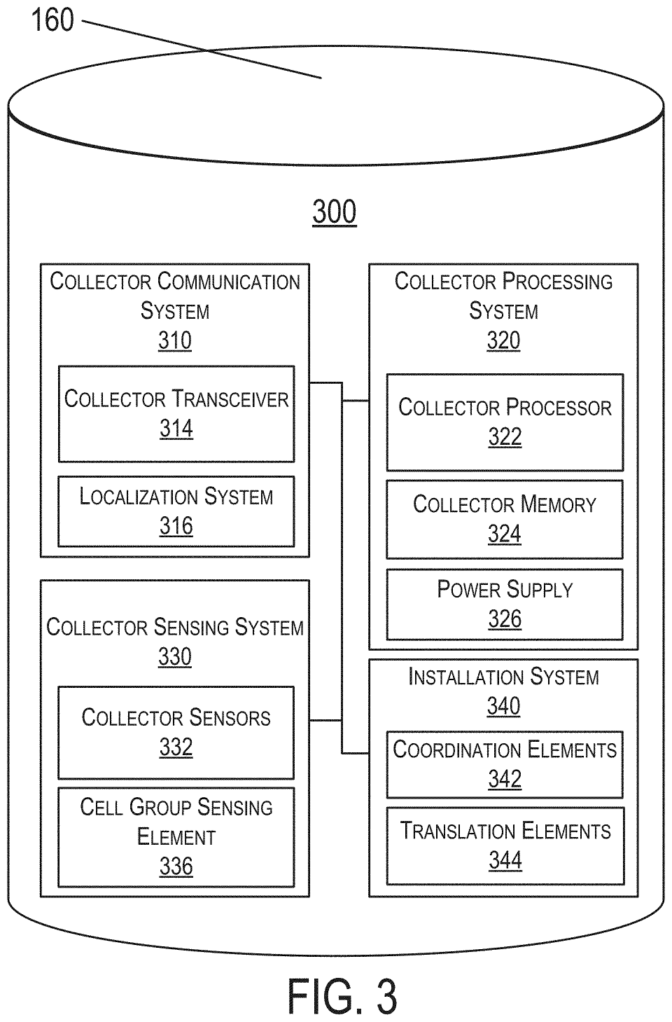

FIG. 3 shows a schematic diagram showing various systems disposed in the collector device 160. In some embodiments, the collector device 160 may be a geophone that includes embedded electronic components that enable the collector device 160 to perform communication functions, data collecting functions, processing functions, and/or translation functions. In some embodiments, the electronic components may be temperature and pressure sensors, batteries, wireless communication capabilities and/or instrumentation capabilities. In some embodiments, one or more batteries are embedded in the collector device 160 to provide the device with maximum power life and operation energy consumption. In some embodiments, various data collecting sensors, a transmitter, and a receiver are also embedded in the collector device 160. The various collecting sensors may collect data relating to the ocean 165 and surrounding conditions of the collector device 160. The transmitter and the receiver may use available, or existing, supervisory control and data acquisition (SCADA) platforms to link the collector device 160 to the panel and/or the controller device 120 to retrieve any data collected.

In offshore applications, the collector device 160 may float along the surface 150 of the ocean 165. The collector device 160 may remain at a predetermined distance from the vessel 125 to allow the reflected signals 155A-155C to reach different Collector devices 160A-160C as shown in FIG. 1. In some embodiments, the collector device 160 includes a collector housing 300 containing a collector communication system 310, a collector processing system 320, a collector sensing system 330, and collector installation system 340. The collector communication system 310 may include communication devices such as a collector transceiver 314, and localization system 316. The transceiver 314 may transmit and receive communication signals. Specifically, the transceiver 314 may communicate with one or more control systems located at a remote location. The transceiver 314 may communicate wirelessly using a wide range of frequencies. In particular, high or ultrahigh frequencies (i.e., between 10 KHz to 10 GHz) may be implemented. The localization system 316 may include one or more geospatial location identification components that collect information associated with a geospatial location of the collector device 160 with respect to the AOI or with respect to the vessel 125.

The collector processing system 320 may include a collector processor 322, a collector memory 324, and a power supply 326. The power supply 326 may be a battery or wired connection for providing electrical energy to the collector device 160. In some embodiments, the battery is charged using electrical connectors (not shown). The collector processor 322 may perform computational processes simultaneously and/or sequentially. The collector processor 322 may determine information to be transmitted and processes to be performed using information received or collected. Similarly, the collector processor 322 may control collection and exchange of geospatial information through the localization system 316.

The collector sensing system 330 may include collector sensors 332 and a cell group sensing element 336. The collector sensors 332 may be sensors that collect physical data from the environment surrounding the collector device 160 (i.e., the surface 155). The collector sensors 332 may be sensors that collect physical data from the collector device 160 itself (i.e., internal temperature, internal pressure, or internal humidity). The collector sensors 332 may be lightweight sensors requiring a small footprint. These sensors may exchange information with each other and supply it to the collector processor 322 for analysis. The cell group sensing element 336 may be a logging tool of an electrical type that establishes communication links with one or more additional collector devices disposed on the surface 150. The cell group sensing element 336 may identify trends, characteristics or properties (i.e., such as pressure or temperature changes) relating to the movement of the collector device 160 and the additional collector devices on the surface 150. The power supply 326 may be operationally connected to the cell group sensing system 336 and including connections (not shown) for collecting energy and producing electrical energy as a result.

The installation system 340 may include coordination elements 342 and translation elements 344. The translation elements 344 may be mechanisms that identify and track the positioning of the collector device 160 with respect to the controller device 120, the AOI, and any additional collector devices in a 3D space.

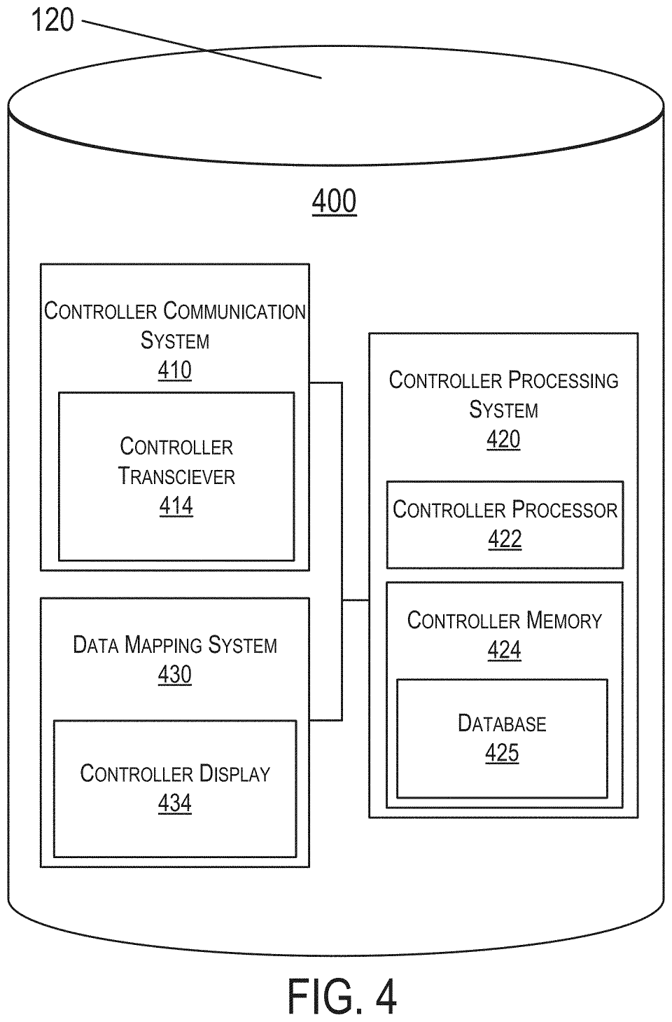

FIG. 4 shows a schematic diagram showing various systems that may be incorporated into the generator device 135. In some embodiments, the controller device 120 includes electronic components that enable the controller device 120 to perform communication functions, data collecting functions, and/or data mapping functions. In some embodiments, the controller device 120 has a controller housing 400 that includes controller communication system 410, controller processing system 420, and data mapping system 430. As noted above, the controller device 120 may be hosted inside the vessel 125 in the manner shown in FIG. 1.

The controller communication system 410 may include communication devices such as a controller transceiver 414. The controller transceiver 414 may transmit and receive communication signals. Specifically, the generator transceiver 414 may communicate with the generator device 135 and one or more collector devices 160 located at a remote location through wired and/or wireless connections.

The controller processing system 420 may include a controller processor 422 and a controller memory 424. The controller processor 422 may perform computational processes simultaneously and/or sequentially. The controller processor 422 may determine information to be transmitted and processes to be performed using information received or collected. The controller memory 424 may include at least one database 425 for mapping one or more data points from the seismic data collected by the collector device 160.

As noted above, seismic data contains information about various geological features. Seismic data collected by the collector device 160 may have various seismic data components at different frequencies containing information about various geological features. At this stage, the seismic data may be used to generate frequency-based horizon interpretation. In this case, horizon interpretation may include horizon picking, as well as the processing of the picked horizon for deriving additional information of a subterranean region. Horizon picking is also referred to as horizon tracking. As noted above, horizon picking refers to a process of determining, selecting, or otherwise identifying a horizon that represents a seismic reflector between two geological layers.

Unlike conventional techniques that perform horizon picking on full stack seismic volumes and use the full bandwidth of frequencies present in the seismic data, the controller device 120 may perform horizon picking based on mono-frequency seismic data (or single-frequency seismic data). For example, horizon interpretations may be performed using seismic volumes that are filtered to a single frequency and then perform the horizon picking on the filtered single-frequency seismic volumes.

The controller device 120 may include a data mapping system 430 that uses the information stored in the database 425 to generate one or more images onto the controller display 434 and relating to one or more depths of the deep reservoir 180. In some embodiments, continuity features of layer reflectors in seismic data may be better observed at single frequency volumes rather than full stack seismic volumes. The continuity may refer to a lateral distance from a specified location and in a specified azimuthal direction for which a reflection character of a seismic event is essentially unchanged. In some embodiments, using mono-frequency seismic data may reduce or remove noise created by different sources that occurs at certain specific frequencies. Similarly, using mono-frequency seismic data may reduce or remove effects of multiples generated from shallow reflectors that would affect an image of a deeper geological reflector. For example, the imaging of specific geological features, such as a boundary between two geological layers may be improved at a specific mono-frequency and the accuracy of horizon picking may be enhanced by using mono-frequency seismic data.

In some implementations, the data mapping system 430 may output a report that includes picked or identified seismic horizons from the seismic data. The output may include one or more interpretations of the horizons. For example, the controller device 120 may decompose the seismic data into different frequency components for an auto picker (i.e., an automated horizon picking system in the data mapping system) to work effectively, which may save interpretation time and improves quality. Once the mono frequency data is picked, peak frequencies may be determined using one or more filtering methods. The results from these filtering procedures may be saved on the database 425 with an assigned illumination value corresponding to the frequency level. In an illumination gradient, peak-frequencies may be brighter than other frequency values such that thinner portions of the deep reservoir 180 may have a larger illumination value.

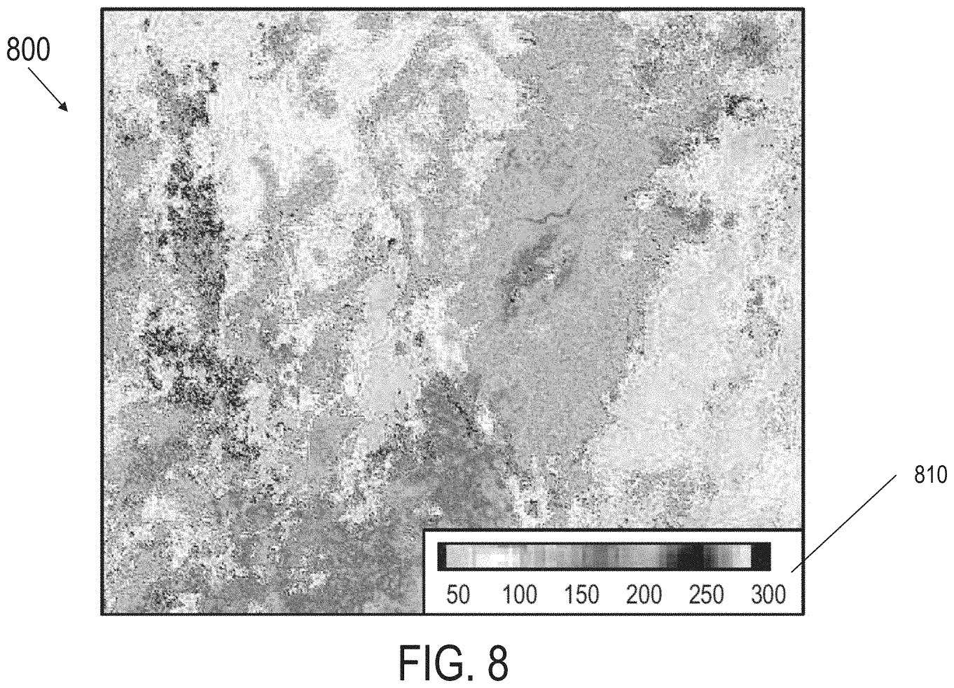

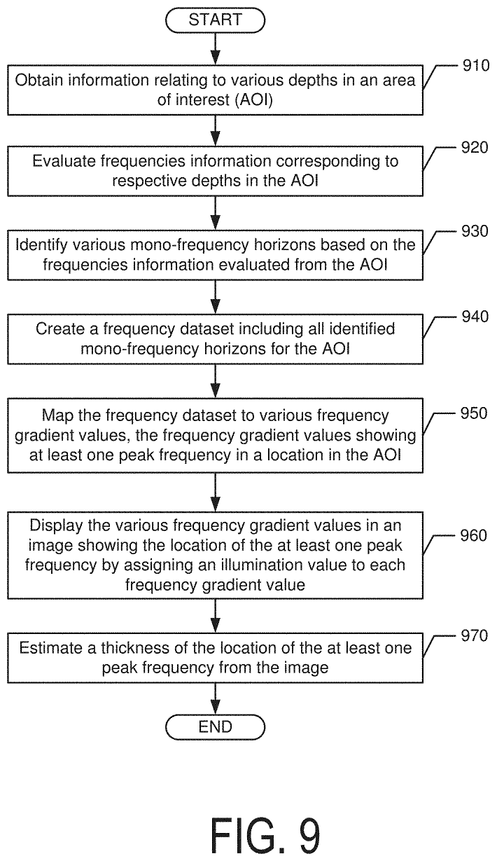

As noted above and as explained in more detail with respect to FIGS. 8 and 9, the thickness of the deep reservoir 180 may be estimated based on an illumination on an image mapping the deep reservoir 180. In this regard, the seismic data may be obtained from an area of interest, the thickness may be calculated using equations (1) and (2), and the results may be mapped from a database onto a map showing an illumination gradient corresponding to a calculated thickness.

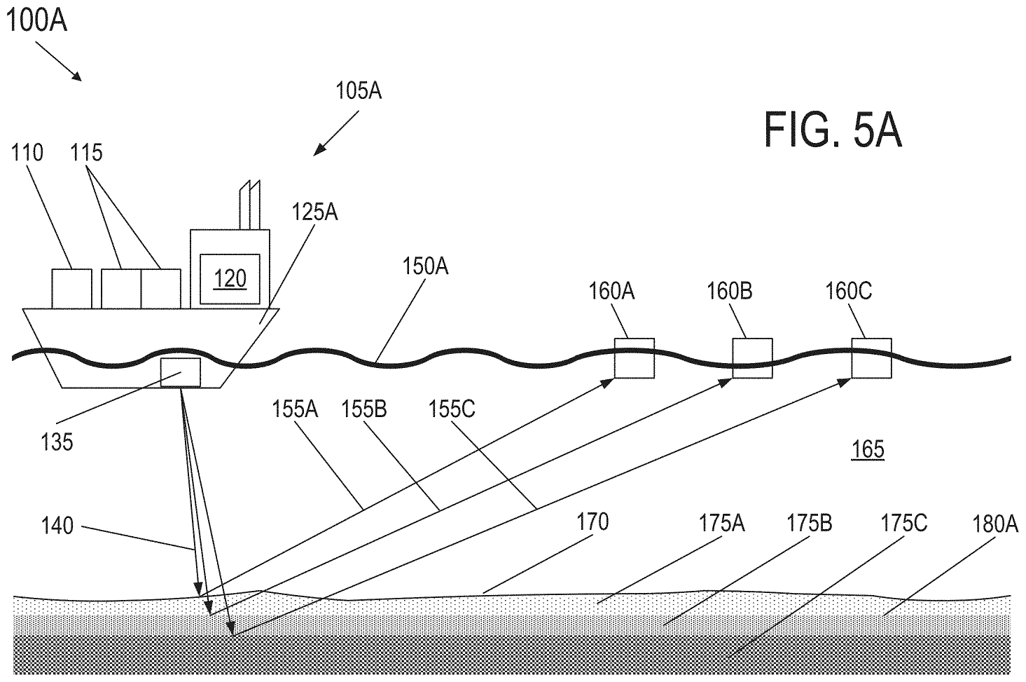

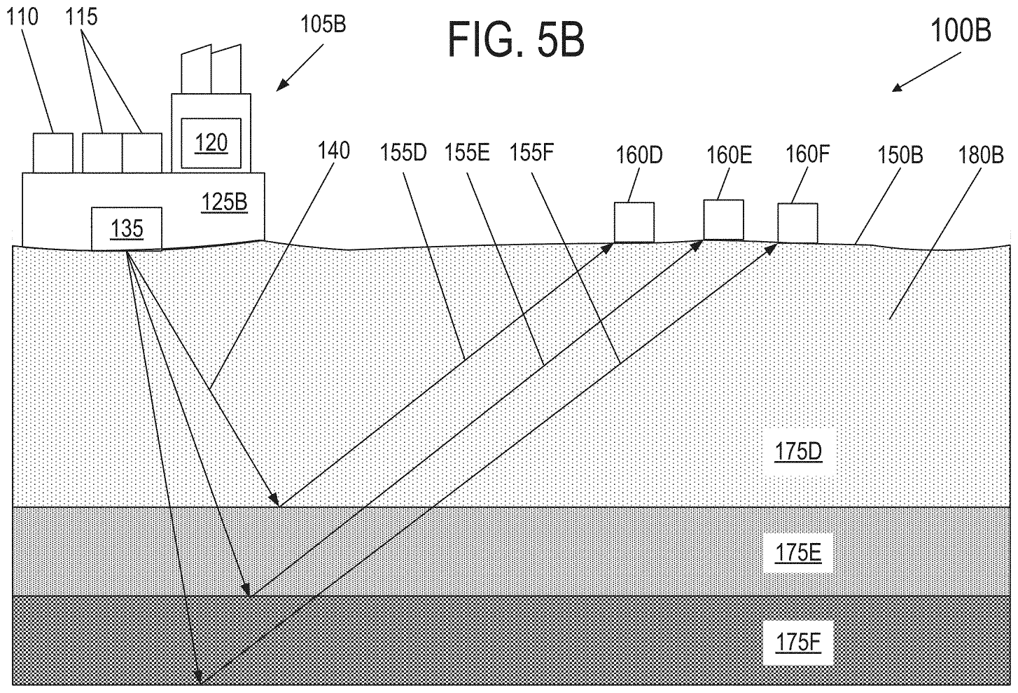

FIG. 5A shows a schematic diagram illustrating an offshore seismic survey system 100A for collecting seismic data from a deep reservoir 180A located below the surface 150A of the ocean 165. The seismic survey system 100A includes the generator device 135 that generates various sampling signals 140 towards the AOI located at the testing surface 170. The testing surface 170 absorbs a portion of the various sampling signals 140 and reflects signals 155A-155C the corresponding depths 175A-175C. Once the reflected signals 155A-155C reach the surface, they may be retrieved by one or more corresponding collector devices 160A-160C. Each collector device out of the collector devices 160A-160C may be located on the ocean surface 150 and disposed at an angle corresponding to a location for receiving the corresponding reflected signals 155A-155C. The collector devices 160A-160C receive the corresponding reflected signals 155A-155C and share the received information with the controller device 120 that processes seismic data received from the reflected signals 155A-155C.

The seismic data is used for frequency-based horizon interpretation. In the offshore seismic survey system 100A, a vessel 125A may act as A surveying site 105A for processing the seismic data. In offshore operations, the generator device 135 may be inside the vessel 125A. As noted above, the vessel 125A may be a movable surveying site or a permanently moored vessel in the manner described in reference to FIG. 1.

FIG. 5B shows a schematic diagram illustrating an onshore seismic survey system 100B for collecting seismic data from a deep reservoir 180B located below the surface 150B of the Earth. The seismic survey system 100B includes the generator device 135 that generates various sampling signals 140 towards the AOI located at the testing surface 170. The testing surface 170 absorbs a portion of the various sampling signals 140 and reflects signals 155D, 155E, and 155F the corresponding depths 175D, 175E, and 175F. Once the reflected signals 155D-155F reach the surface, they may be retrieved by one or more corresponding collector devices 160D, 160E, and 160F. Each collector device out of the collector devices 160D-160F may be located on the surface 150 and disposed at an angle corresponding to a location for receiving the corresponding reflected signals 155D-155F. The collector devices 160D-160F receive the corresponding reflected signals 155D-155F and share the received information with the controller device 120 that processes seismic data received from the reflected signals 155D-155F.

The seismic data is used for frequency-based horizon interpretation. The onshore seismic survey system 100B may act as a surveying site 105B for processing the seismic data. In onshore operations, the generator device 135 may be inside the building 125B. The building 125B may a location acting in a similar manner to the vessel 125A in manner described in reference to FIG. 1.

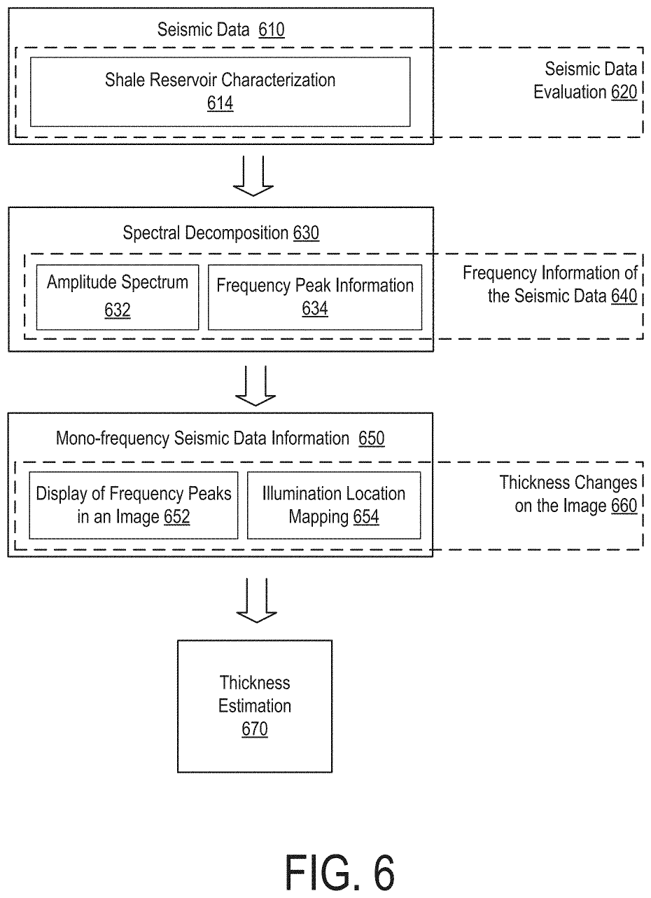

FIG. 6 shows a schematic diagram for an example in accordance with one or more embodiments. In one or more embodiments, the method and the system include a new scheme for estimating a thickness in a deep reservoir. The method and the system may process measured physical phenomena to perform thickness estimation.

In some embodiments, the process starts by obtaining seismic data 610. The seismic data 610 is received by the controller device 120 and it includes information resulting from the combination of the sampling signals 140 and the reflected signals 155A-155C as described in reference to FIG. 1. A seismic data evaluation 620 is used to determine whether the collected seismic data 610 is relevant to determine the thickness of the deep reservoir. In some embodiments, the seismic data evaluation 620 involves a shale reservoir characterization 614 based on the changes of frequency and timing in the reflected signals 155A-155C as received by the collector devices 160A-160C.

Once the seismic data 610 is received and validated as such, the frequency characteristics of thin reservoirs may be derived. Specifically, various frequency components of an amplitude spectrum 632 of the seismic data 610 may be obtained through spectral decomposition 630. At this point, thin reservoirs may be picked at mono-frequency horizons corresponding to high frequencies of the spectrum based on high frequency peaks in the amplitude spectrum 632. At the same time, high frequency peak information 634 may be identified as the frequency where the thin reservoirs show a highest degree of contrast in the seismic data (i.e., larges frequency difference). As noted above, as frequency information of the seismic data 641 is broken down into its individual physical components, the controller device 120 identifies the peak frequency by identifying events corresponding to thin reservoirs at mono-frequency horizons of high frequencies. The peak frequency may be used together with the interval velocity to directly estimate a thickness.

Once the mono-frequency horizons and frequency peaks have been identified or determined, mono-frequency seismic data information 650 may be processed to illustrate a mapping of the frequency information of the seismic data 640. In this characterization, the frequency information is broken down into its individual components and each component is given a corresponding weight to provide an illumination value or an illumination gradient. Specifically, a display of the frequency peaks in an image 652 may be prepared to associate the frequency peaks to a location in an image representing topographical changes in the deep reservoir. In the image, an illumination location mapping 654 provides a clear positioning of the different illumination gradient values to corresponding locations in the image. Once the illumination location mapping 654 has been established, thickness changes on the image 660 may be determined to finally perform a thickness estimation 670 of the deep reservoir based on the image obtained using the seismic data 610.

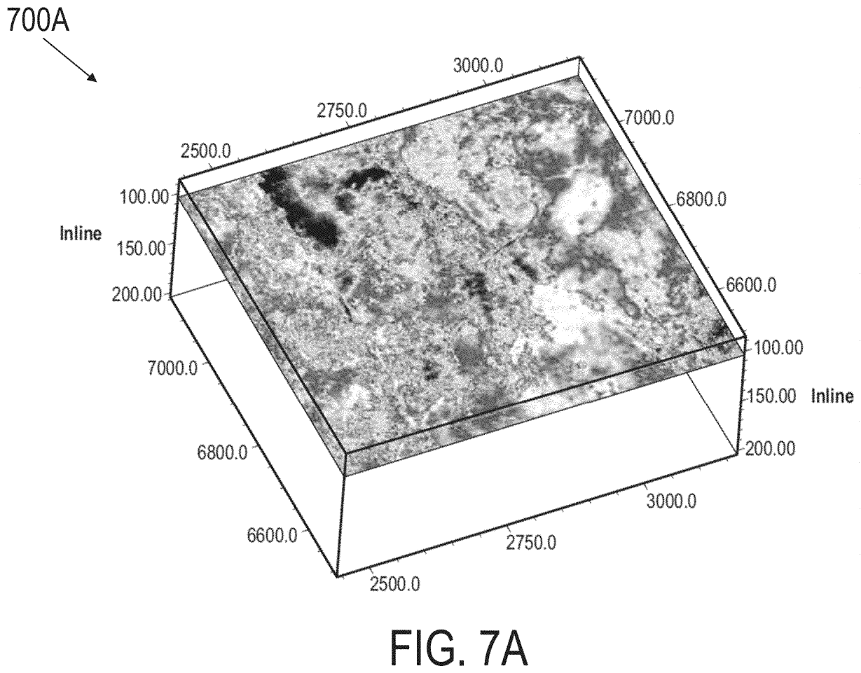

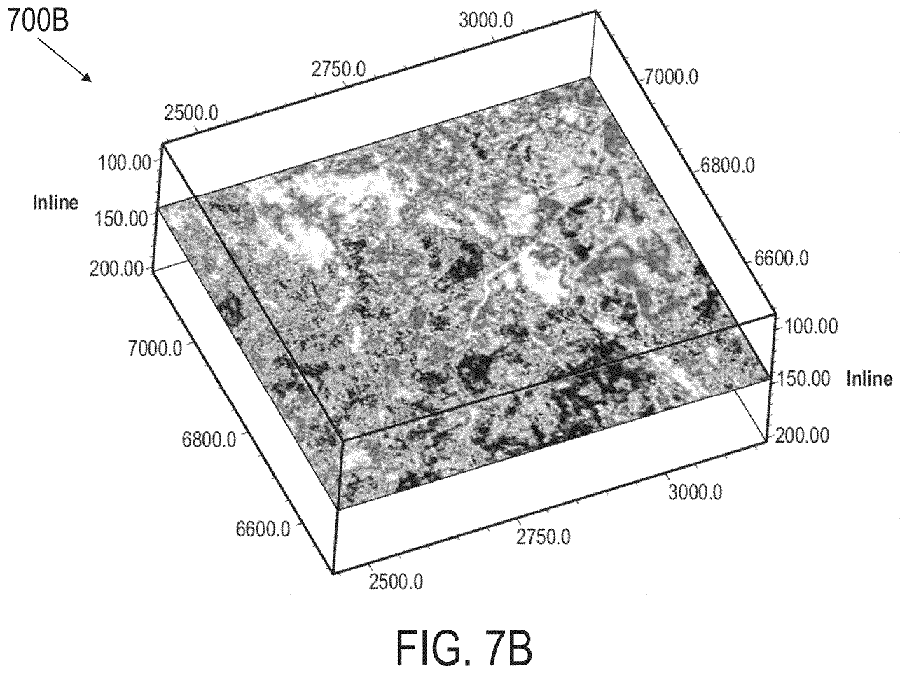

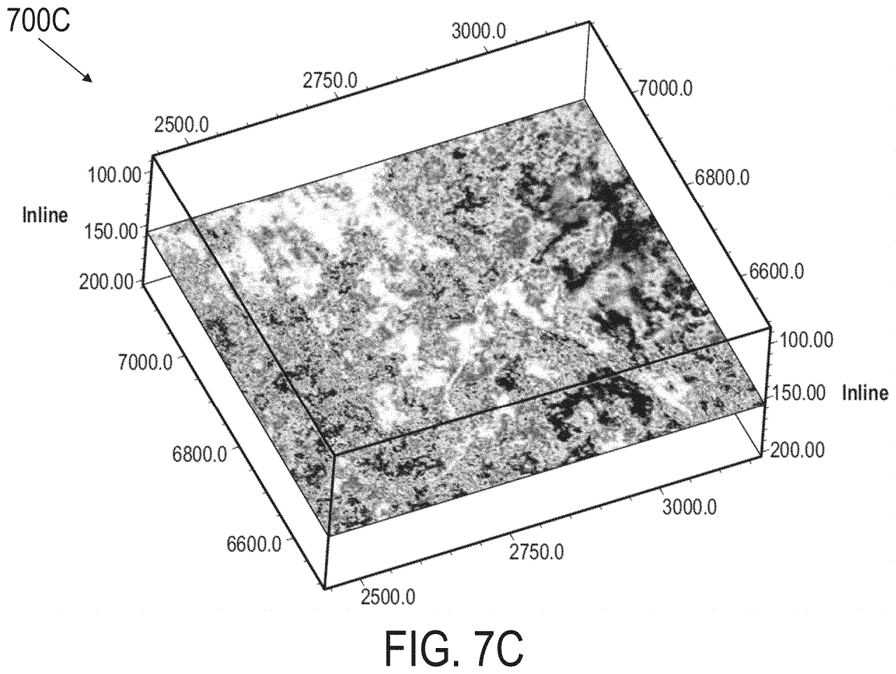

FIGS. 7A, 7B, and 7C are examples of images generated based on seismic data obtained using a seismic survey system 100. As noted above, the seismic data may be retrieved with signals having a frequency bandwidth ranging from 10 Hz to 1000 Hz. A search step of 5 Hz, 10 Hz, or similar values may be used by the controller device 120 to find a single frequency that gives rise to a predetermined continuity along a target horizon. In some embodiments, the search may start by selecting or otherwise identifying a representative 2D seismic line by the controller device 120. As described above, the controller device 120 may decompose the seismic data into mono-frequencies, assess the horizon continuity level at each frequency, and select the frequency that gives rise to the predetermined continuity.

In these examples, estimating thicknesses of deep reservoirs is performed by identifying the peak frequency after determining events corresponding to thin reservoirs at mono-frequency horizons of high frequencies. These mono-frequency horizons are obtained through spectral decomposition. Then the peak frequency is used together with the interval velocity to directly calculate thickness. In some embodiments, to estimate thickness, the one-way travel time of seismic waves with a geologic layer T can be approximated as a function of the high peak frequency (i.e., fₚₑₐₖ) using equation (1).

And based on equation (1), the thickness of any geologic layer Z can be estimated in equation (2). As described above, the thickness may be estimated based on an illumination on an image mapping the deep reservoir. In this regard, the seismic data may be obtained from an area of interest, the thickness may be calculated using equations (1) and (2), and the results may be mapped from a database onto a map showing an illumination gradient corresponding to a calculated thickness.

In experiments performed, applying the method and the system to a real dataset resulted in estimated thickness of a thin reservoir that is very close to the observed actual thickness in a drilled well. In this regard, as it will be shown in FIGS. 7A-7C, the method and the system improve petroleum exploration as the method and the system improve characterization of deep thin reservoirs using seismic data as a starting point. Specifically, the method was applied to a real dataset to estimate the thickness of a real thin reservoir at a depth greater than 14000 ft. In this case, strong illuminations in the vicinity of thin reservoirs were observed at high frequencies (i.e., greater than 40 Hz). Then, the estimated frequency was converted to thickness. The estimated thickness through the method is about 150 ft whereas the actual thickness at the well is 170 ft. This shows an overall all reliable estimation of thickness of a thin reservoir that is not resolvable by conventional seismic interpretation techniques as the tuning thickness of the data is 250 ft.

FIGS. 7A-7C show images 700A, 700B, and 700C mono-frequency horizons corresponding to the frequency values of 16 Hz, 36 Hz and 41 Hz, respectively. Some events, interpreted to be a thin reservoir, are highly illuminated at the 41 Hz horizon and these event are dim at the 16 Hz horizon. These events are observed near the left bottom corner of the corresponding images. The peak frequency for these events is determined to be 41 Hz.

FIG. 8 shows an image 800 resulting from the thickness estimation as carried out based on the peak frequency values and following equation (2). The resulting thickness map shows a thickness of about 150 ft (as identified by the legend slider 810) for the thin reservoir near the left bottom corner. In this process, proper processing of the seismic data is carried out by the controller device 120. Further, the quality of the seismic data at the depth of the targeted reservoir for petroleum exploration is carried out by a predetermined deployment of the collector devices 160 and the targeting of the AOI using the generator device 135.

FIG. 9 shows a flowchart in accordance with one or more embodiments. Specifically, FIG. 9 describes a method for estimating a thickness of a deep reservoir. In some embodiments, the method may be implemented using the devices described in reference to FIGS. 1-8. While the various blocks in FIG. 9 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The method allows thickness estimation in petroleum exploration without heavily depending on interpreting petroleum reservoirs using seismic data and converting the interpreted reservoirs to depth. Specifically, the method is successful in resolving reservoirs that are difficult to resolve using conventional seismic data. In this regard, the method uses collected frequency information to estimate thickness by enabling assessment of the thickness of deep thin reservoirs based on peak seismic frequency information.

In Block 910, information relating to various depths is obtained of the AOI. One or more collector devices (i.e., acting as geophones) may gather reflected signals in real-time and they are received instantaneously in a recording station connecting to one or more control systems. In this regard, seismic surveys may be conducted by creating a shock wave—a seismic wave—on the surface of the ground along a predetermined line, using an energy source. The seismic wave travels into the Earth, is reflected by subsurface formations, and returns to the surface where it is recorded by collector devices.

In Block 920, frequencies information is evaluated corresponding to the respective depths in the AOI. Reflected signals are sampled in the time domain (i.e., sampled according to their two-way travel time) using the collector devices. The data recorded from the seismic surveys is “raw” or “unprocessed” form until it is processed. Processing of the data recorded includes filtering, stacking, migrating, and other computer analysis to transform the recorded data.

In Block 930, various mono-frequency horizons are identified based on the frequencies information evaluated from the AOI. As described in FIG. 6, the mono-frequency horizons may be determined by the controller device 120. By analyzing the time it takes for the seismic waves to reflect off of subsurface formations and return to the surface, a geophysicist can map subsurface formations and anomalies and predict where hydrocarbons may be trapped in sufficient quantities for exploration activities.

In Block 940, a frequency dataset is created including all identified mono-frequency horizons. In the frequency dataset, peak frequency values are identified using equations (1) and (2). A new dataset may be created based on new information obtained from the seismic data or based on updated information from an existing dataset. For example, a new seismic volume attribute of a particular mono-frequency may be used to update an existing dataset and a new dataset may be created as a result.

In Block 950, the frequency dataset is mapped to various frequency gradient values. At this point, the frequency gradient values are processed to show at least one peak frequency in a location in the AOI.

In Block 960, the various frequency gradient values are displayed in an image showing the location of the at least one peak frequency by assigning an illumination value to each frequency gradient value. For example, there might be at least one peak frequency with an increase in an amplitude of a frequency range around it (i.e., frequency band).

In Block 970, the thickness of the location of the at least one peak frequency is estimated from the image. The contrast range provides a clear representation of areas based on frequency changes corresponding to the topography of the deep surface. The thickness may be estimated by identifying the locations with increased contrast on the image.

While FIGS. 1-9 show various configurations of components, other configurations may be used without departing from the scope of the disclosure. For example, various components in FIG. 1-5 may be combined to create a single component. As another example, the functionality performed by a single component may be performed by two or more components.

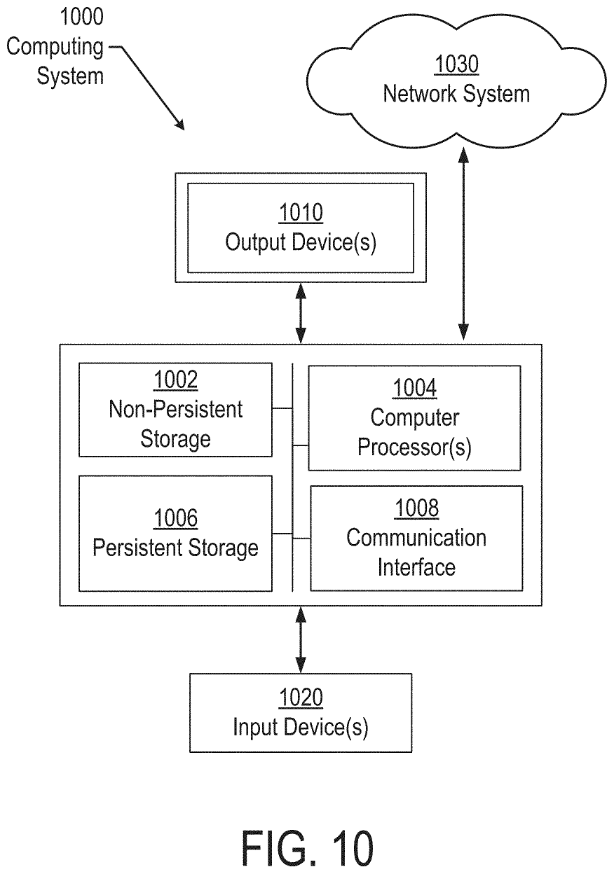

As shown in FIG. 10, the computing system 1000 may include one or more computer processor(s) 1004, non-persistent storage 1002 (e.g., random access memory (RAM), cache memory, or flash memory), one or more persistent storage 1006 (e.g., a hard disk), a communication interface 1008 (transmitters and/or receivers) and numerous other elements and functionalities. The computer processor(s) 1004 may be an integrated circuit for processing instructions. The computing system 1000 may also include one or more input device(s) 1020, such as a touchscreen, keyboard, mouse, microphone, touchpad, electronic pen, or any other type of input device. In some embodiments, the one or more input device(s) 1020 may be a surface panel connected to the controller device 120 described in reference to FIG. 1. Further, the computing system 1000 may include one or more output device(s) 1010, such as a screen (e.g., a liquid crystal display (LCD), a plasma display, or touchscreen), a printer, external storage, or any other output device. One or more of the output device(s) may be the same or different from the input device(s). The computing system 1000 may be connected to a network system 1030 (e.g., a local area network (LAN), a wide area network (WAN) such as the Internet, mobile network, or any other type of network) via a network interface connection (not shown).

In one or more embodiments, for example, the input device 1020 may be coupled to a receiver and a transmitter used for exchanging communication with one or more peripherals connected to the network system 1030. The receiver may receive information relating to one or more reflected signals 155A-155C as described in reference to FIG. 1. The transmitter may relay information received by the receiver to other elements in the computing system 1000. Further, the computer processor(s) 1004 may be configured for performing or aiding in implementing the processes described in reference to FIGS. 6 and/or 9.

Further, one or more elements of the computing system 1000 may be located at a remote location and be connected to the other elements over the network system 1030. The network system 1030 may be a cloud-based interface performing processing at a remote location from the well site and connected to the other elements over a network. In this case, the computing system 1000 may be connected through a remote connection established using a 5G connection, such as protocols established in Release 15 and subsequent releases of the 3GPP/New Radio (NR) standards.

The computing system in FIG. 10 may implement and/or be connected to a data repository. For example, one type of data repository is a database (i.e., like database 425). A database is a collection of information configured for ease of data retrieval, modification, re-organization, and deletion. In some embodiments, the database includes published/measured data relating to the method, the assemblies, and the devices as described in reference to FIGS. 1-5.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method for estimating a thickness of a deep reservoir, the method comprising:
obtaining seismic data relating to the deep reservoir;
performing spectral decomposition to obtain one or more frequency components from the seismic data;
identifying a number of mono-frequency horizons corresponding to high frequencies in the seismic data;
determining whether the deep reservoir is a thin reservoir based on the number of mono-frequency horizons; and
estimating the thickness of the deep reservoir when the deep reservoir is determined to be the thin reservoir.

2. The method of claim 1, wherein the seismic data is information relating to various depths in an area of interest (AOI).

3. The method of claim 2, the method further comprising:
evaluating frequency information corresponding to respective depths in the AOI.

4. The method of claim 3, wherein the number of mono-frequency horizons is identified based on the frequencies information evaluated from the AOI.

5. The method of claim 4, the method further comprising:
creating a frequency dataset including all identified mono-frequency horizons for the AOI.

6. The method of claim 5, the method further comprising:
mapping the frequency dataset to various frequency gradient values, the frequency gradient values showing at least one peak frequency in a location in the AOI.

7. The method of claim 6, the method further comprising:
displaying the various frequency gradient values in an image showing the location of the at least one peak frequency by assigning an illumination value to each frequency gradient value.

8. The method of claim 2,
wherein the seismic data is collected using a seismic survey system, the seismic survey system comprising:
a generator device that transmits a signal to the AOI,
a collector device that obtains a response to the signal from the AOI, and
a controller device that determines the seismic data based on the signal and the response to the signal, and
wherein the AOI is located in a submarine area.

9. A seismic survey system, the system comprising:
a generator device that transmits a signal to an area of interest (AOI);
a collector device that obtains a response to the signal from the AOI; and
a controller device that:
determines seismic data based on the signal and the response to the signal,
performs spectral decomposition to obtain one or more frequency components from the seismic data,
identifies a number of mono-frequency horizons corresponding to high frequencies in the seismic data,
determines whether the deep reservoir is a thin reservoir based on the number of mono-frequency horizons, and
estimates the thickness of the deep reservoir when the deep reservoir is determined to be the thin reservoir.

10. The system of claim 9, the controller device further evaluates frequency information corresponding to respective depths in the AOI.

11. The system of claim 10, wherein the number of mono-frequency horizons is identified based on the frequencies information evaluated from the AOI.

12. The system of claim 11, the controller device further creates a frequency dataset including all identified mono-frequency horizons for the AOI.

13. The system of claim 12, the controller device further maps the frequency dataset to various frequency gradient values, the frequency gradient values showing at least one peak frequency in a location in the AOI.

14. The system of claim 13, the controller device further displays the various frequency gradient values in an image showing the location of the at least one peak frequency by assigning an illumination value to each frequency gradient value.

15. A non-transitory computer readable medium storing instructions executable by a computer processor, the instructions comprising functionality for:
obtaining seismic data relating to the deep reservoir;
performing spectral decomposition to obtain one or more frequency components from the seismic data;
identifying a number of mono-frequency horizons corresponding to high frequencies in the seismic data;
determining whether the deep reservoir is a thin reservoir based on the number of mono-frequency horizons; and
estimating the thickness of the deep reservoir when the deep reservoir is determined to be the thin reservoir.

16. The non-transitory computer readable medium of claim 15, wherein the seismic data is information relating to various depths in an area of interest (AOI).

17. The non-transitory computer readable medium of claim 16, the instructions further comprising functionality for:
evaluating frequency information corresponding to respective depths in the AOI.

18. The non-transitory computer readable medium of claim 17, wherein the number of mono-frequency horizons is identified based on the frequencies information evaluated from the AOI.

19. The non-transitory computer readable medium of claim 18, the instructions further comprising functionality for:
creating a frequency dataset including all identified mono-frequency horizons for the AOI,
mapping the frequency dataset to various frequency gradient values, the frequency gradient values showing at least one peak frequency in a location in the AOI, and
displaying the various frequency gradient values in an image showing the location of the at least one peak frequency by assigning an illumination value to each frequency gradient value.

20. The non-transitory computer readable medium of claim 16,
wherein the seismic data is collected using a seismic survey system, the seismic survey system comprising:
a generator device that transmits a signal to the AOI,
a collector device that obtains a response to the signal from the AOI, and
a controller device that determines the seismic data based on the signal and the response to the signal, and
wherein the AOI is located in a submarine area.
